(19) United States
(12) Patent Application Publication
(10) Pub. No.: US 2018/0359072 A1
(43) Pub. Date: Dec. 13, 2018

(54) Hybrid Automatic Repeat Request Acknowledgment Feedback Using Periodic and Aperiodic Physical Uplink Control Channel Resources

(71) Applicant: Nokia Solutions and Networks Oy, Espoo (FI)

(72) Inventors: Esa Tapani TIIROLA, Kempele (FI); Timo Erkki LUNTTILA, Espoo (FI); Kari Juhani HOOLI, Oulu (FI)

(21) Appl. No.: 16/060,115

(22) PCT Filed: Nov. 22, 2016
(86) PCT No.: PCT/EP2016/078419

§ 371 Date: Jun. 7, 2018

(30) Foreign Application Priority Data
Dec. 8, 2015 (EP) PCT/EP2015/079002

(51) Int. Cl. H04L 5/00; H04L 1/18; H04W 74/08; H04W 72/04

(52) U.S. Cl. CPC H04L 5/0055; H04L 1/1812; H04W 72/0413; H04L 1/1854; H04W 74/0808; H04L 1/1896

(57) ABSTRACT

Various communication systems may benefit from an appropriate usage of resources. For example, certain wireless communication systems may benefit from appropriate usage of periodic and aperiodic physical uplink control channel resources for hybrid automatic repeat request acknowledgment feedback. A method can include receiving, from an access node, an acknowledgment/negative acknowledgement resource indicator in a downlink assignment. The indicator can correspond to two or three resource sets. The method can also include determining, by a user equipment, a resource for hybrid automatic repeat request acknowledgment transmission based on the acknowledgment/negative acknowledgement resource indicator and based on an outcome of a listen before talk procedure.

### BACKGROUND

### Field

Various communication systems may benefit from an appropriate usage of resources. For example, certain wireless communication systems may benefit from appropriate usage of periodic and aperiodic physical uplink control channel resources for hybrid automatic repeat request acknowledgment feedback.

### Description of the Related Art

Release 13 (Rel-13) of long term evolution (LTE) of licensed assisted access (LAA) provides licensed-assisted access to unlicensed spectrum while coexisting with other technologies and fulfilling the regulatory requirements. In Rel-13 LAA, unlicensed spectrum is utilized to improve LTE downlink (DL) throughput. One or more LAA DL secondary cells (SCells) may be configured to a user equipment (UE) as part of DL carrier aggregation (CA) configuration, while a primary cell (PCell) may need to be on licensed spectrum. Rel-13 LTE LAA may evolve to also support LAA UL transmissions on unlicensed spectrum in LTE Rel-14.

Standardized LTE LAA solution in Rel-13 based on CA framework assumes transmission of uplink control information (UCI) on PCell, namely in the licensed band. However, there may be an extension of LAA with dual connectivity operation, allowing for non-ideal backhaul between PCell in licensed spectrum and SCell(s) in unlicensed spectrum. Additionally, there may be extension to standalone LTE operation on unlicensed spectrum. LTE standalone operation on unlicensed spectrum means that evolved Node B (eNB)/UE air interface may rely solely on unlicensed spectrum without any carrier on licensed spectrum. Both dual connectivity and standalone operation modes may need transmission of UCI/PUCCH on unlicensed spectrum. It's also possible to define UCI/PUCCH functionality e.g. as part of Rel-14 LAA even without support for standalone or dual connectivity operation on licensed carrier, e.g. in order to facilitate PUCCH offloading to from Macro cell to one or more unlicensed cells.

In LTE operation on unlicensed carriers, depending on the regulatory rules, the UE may need to perform listen before talk (LBT) prior to any UL transmission. Some exceptions may exist though. For example, at least in some regions, transmission of ACK/NACK feedback may be possible without LBT when immediately following a DL transmission, similar to WiFi operation. Short control signaling (SCS) rules defined for Europe by ETSI allow for transmission of control signaling with a duty cycle of no more than 5% over 50 ms period without performing LBT:

Short control signaling transmissions can refer to transmissions used by adaptive equipment to send management and control frames, such as ACK/NACK signals, without sensing the channel for the presence of other signals. It is not required for adaptive equipment to implement short control signaling transmissions.

If implemented, short control signaling transmissions of adaptive equipment may have, for example, a maximum duty cycle of 5% within an observation period of 50 ms.

At least in some regions, scheduled UL transmissions may in general be allowed without LBT, when the transmission follows directly a DL transmission before which the eNodeB has performed LBT and total transmission time covering both DL and UL is limited by the maximum Tx burst time defined by the regulator.

To ensure reliable operation with LBT, transmissions may be required to occupy effectively the whole nominal channel bandwidth (BW). This means that UL transmissions such as PUCCH and physical uplink scheduling channel (PUSCH) may be required to occupy a large BW. This can be achieved using interleaved frequency division multiple access (IFDMA), block-IFDMA as described in 3GPP R1-152815, or contiguous resource allocation. Each allocation with legacy subframe duration of 1 ms may include a large number of resource elements. Accordingly, a shorter duration of PUCCH (“Short PUCCH”) may offered, with application of time division multiplexing (TDM) between different channels such as PUCCH and PUSCH. Additionally, use of TDM in UL can be seen as feasible since typically the target scenario involves small cell, meaning that UE does not become power limited even with wider bandwidth allocations. Furthermore, TDM allows minimization of the short PUCCH duration and thereby maximization of the room for DL and UL shared channels.

On the other hand, dynamically triggered “Long PUCCH” may be used support extreme cell edge conditions and very large UCI payload.

In short, two basic PUCCH structures/containers are seen: short PUCCH, which can refer to a PUCCH structure occupying few symbols, such as 4 symbols, and which can be TDMed with PUSCH (In principle it is possible to FDM also short PUCCH with PUSCH.); and long PUCCH, which can refer to a PUCCH structure occupying a PUSCH B-IFDMA interlace and predefined transmission timing, such as 1 ms, and which can be FDMed with PUSCH. Short PUCCH may support multiple Short PUCCH formats. For example, there may be a Short PUCCH format designed for transmission of multiple HARQ-ACK bits, another Short PUCCH format designed for transmission of PRACH, SR, SRS and yet another Short PUCCH format designed for transmission of bundled HARQ-ACK.

Three different PUCCH transmission timing principles may be used in certain embodiments. Fast PUCCH is a transmission timing principle in which HARQ ACK/NACK transmission occurs on Short PUCCH following right after the corresponding DL Tx burst. Slow PUCCH is a transmission timing principle in which HARQ ACK/NACK transmission occurs “later on” on a PUCCH resource. Slow PUCCH transmission may be triggered by eNB. Periodic PUCCH is a transmission timing principle in which a periodic PUCCH resource is configured for the UE.

FIG. 1 illustrates a use of a combination of approaches. LBT may prevent fast PUCCH transmission on the following short PUCCH. Additionally, UE processing time limitation may prevent processing each subframe of DL transmission burst before fast PUCCH. Hence, multiple timing solutions may be used for PDSCH HARQ-ACK, including slow PUCCH.

Different options may be used for slow PUCCH transmission. These options include dynamic triggering of slow PUCCH transmission containing PDSCH HARQ-ACK. In this option, transmission of PDSCH HARQ-ACK on Short PUCCH resources can be triggered dynamically or, alternatively, PDSCH HARQ-ACK can be conveyed as UCI on PUSCH (with or without PUSCH data). Another option is to use Periodic PUCCH resources. A third option is to use fast PUCCH resource on short PUCCH corresponding to the next DL Tx burst. Yet another option is to trigger short PUCCH dynamically.

FIG. 2 illustrates periodic PUCCH with and without listen before talk. Periodic PUCCH resources may be needed for random access (RA) preamble, physical random access channel (PRACH), sounding reference signal (SRS), and scheduling request (SR). Periodic PUCCH resources can be made available also for PDSCH HARQ-ACK transmission. Part of Short PUCCH resources may be reserved for Periodic PUCCH use such RA preamble, SR and SRS). Periodic PUCCH resources may be configured to some of UEs. Periodic PUCCH can also be seen as an alternative or a complementing solution for dynamically triggered Short PUCCH transmission for PDSCH HARQ-ACK transmission.

As shown in FIG. 2, case 1 is periodic PUCCH operated without LBT. This case may follow, for example, short control signaling rules defined for Europe by ETSI. This case may involve deterministic usage of periodic PUCCH resources. For example, 4 single carrier frequency division multiple access (SC-FDMA) symbols/10 ms can correspond to an overhead of 2.9% (<5%).

Case 2 can be to apply one-shot LBT for Periodic PUCCH. In this case, PUCCH can be dropped in the case of negative LBT. This case may apply opportunistic usage of periodic PUCCH resources based on LBT.

FIG. 3 illustrates interaction among different PUCCH formats and timing approaches. As shown in FIG. 3, short PUCCH format is consistent with fast aperiodic PUCCH and with periodic PUCCH. It is somewhat consistent with slow triggered PUCCH. By contrast, long PUCCH is more consistent with slow triggered PUCCH timing. Thus, long PUCCH (e.g. with 1 ms duration) may be used only when triggered by eNB. By contrast, short PUCCH (e.g. with 4-symbol duration) has three different timing options (right after DL Tx burst, triggered by eNB with a predefined timing and Periodic PUCCH following a separate configuration).

### SUMMARY

According to certain embodiments, a method can include receiving, from an access node, an acknowledgment/negative acknowledgement resource indicator in a downlink assignment. The indicator can correspond to two or three resource sets. The method can also include determining, by a user equipment, a resource for hybrid automatic repeat request acknowledgment transmission based on the acknowledgment/negative acknowledgement resource indicator and based on an outcome of a listen before talk procedure.

In certain embodiments, a method can include deciding a resource to be used by a user equipment for hybrid automatic repeat request acknowledgment transmission. The method can also include indicating, by an access node, the resource using an acknowledgment/negative acknowledgement resource indicator in a downlink assignment. The indicator can correspond to two or three resource sets. The indicator can be configured to be considered in combination with an outcome of a listen before talk procedure.

An apparatus, according to certain embodiments, can include at least one processor and at least one memory including computer program code. The at least one memory and the computer program code can be configured to, with the at least one processor, cause the apparatus at least to receive, from an access node, an acknowledgment/negative acknowledgement resource indicator in a downlink assignment. The indicator can correspond to two or three resource sets. The at least one memory and the computer program code can also be configured to, with the at least one processor, cause the apparatus at least to determine, by a user equipment, a resource for hybrid automatic repeat request acknowledgment transmission based on the acknowledgment/negative acknowledgement resource indicator and based on an outcome of a listen before talk procedure.

An apparatus, in certain embodiments, can include at least one processor and at least one memory including computer program code. The at least one memory and the computer program code can be configured to, with the at least one processor, cause the apparatus at least to decide a resource to be used by a user equipment for hybrid automatic repeat request acknowledgment transmission. The at least one memory and the computer program code can also be configured to, with the at least one processor, cause the apparatus at least to indicate, by an access node, the resource using an acknowledgment/negative acknowledgement resource indicator in a downlink assignment. The indicator can correspond to two or three resource sets. The indicator can be configured to be considered in combination with an outcome of a listen before talk procedure.

According to certain embodiments, an apparatus can include means for receiving, from an access node, an acknowledgment/negative acknowledgement resource indicator in a downlink assignment. The indicator can correspond to two or three resource sets. The apparatus can also include means for determining, by a user equipment, a resource for hybrid automatic repeat request acknowledgment transmission based on the acknowledgment/negative acknowledgement resource indicator and based on an outcome of a listen before talk procedure.

In certain embodiments, an apparatus can include means for deciding a resource to be used by a user equipment for hybrid automatic repeat request acknowledgment transmission. The apparatus can also include means for indicating, by an access node, the resource using an acknowledgment/negative acknowledgement resource indicator in a downlink assignment. The indicator can correspond to two or three resource sets. The indicator can be configured to be considered in combination with an outcome of a listen before talk procedure.

A computer program product can, according to certain embodiments, encode instructions for performing a process. The process can include any of the above-described methods.

A non-transitory computer-readable medium can, in certain embodiments, be encoded with instructions that, when executed in hardware, perform a process. The process can include any of the above-described methods.

### BRIEF DESCRIPTION OF THE DRAWINGS

For proper understanding of the invention, reference should be made to the accompanying drawings, wherein:

FIG. 1 illustrates a use of a combination of approaches.

FIG. 2 illustrates periodic PUCCH with and without listen before talk.

FIG. 3 illustrates interaction among different PUCCH formats and timing approaches.

FIG. 4 illustrates principles of certain embodiments.

FIG. 5 illustrates further principles of certain embodiments.

FIG. 6 illustrates table 1, several options according to certain embodiments.

FIG. 7 illustrates a method according to certain embodiments.

FIG. 8 illustrates a system according to certain embodiments.

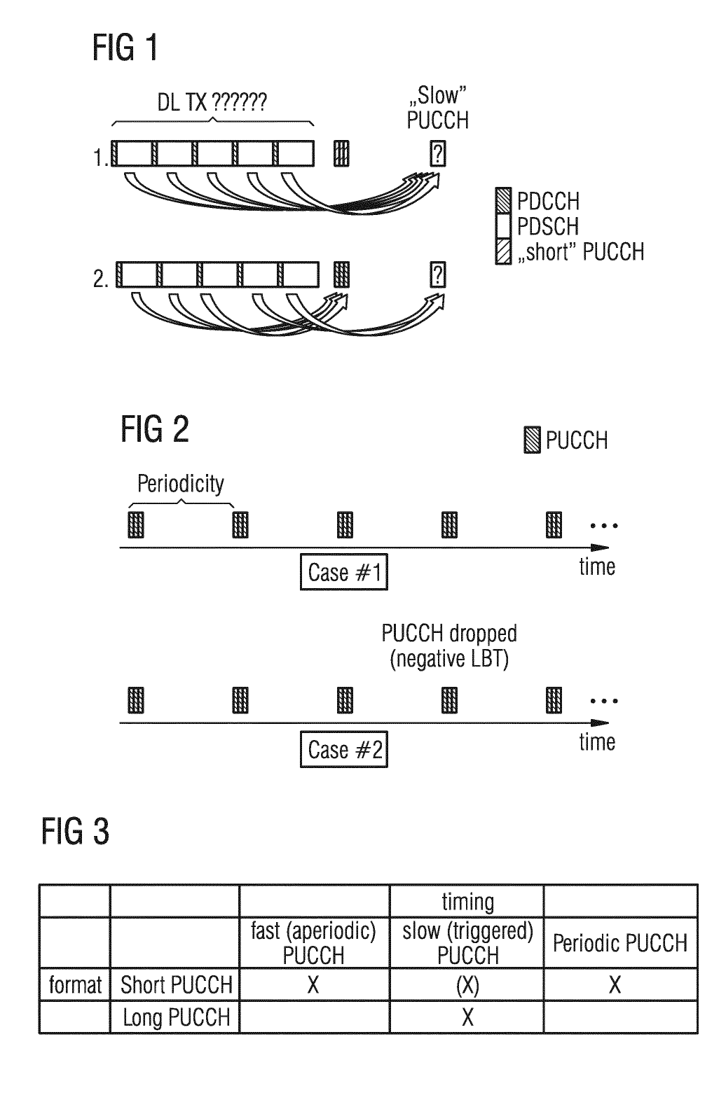

### DETAILED DESCRIPTION

Certain embodiments relate transmission of uplink (UL) control information, such as hybrid automatic repeat request acknowledgment (HARQ-ACK) feedback, on unlicensed spectrum subject to listen-before-talk (LBT) rules. Periodic physical uplink control channel (PUCCH) resources maybe needed for certain signals such as physical random access channel (PRACH), sounding reference signal (SRS), and scheduling request (SR). Certain embodiments provide a solution for using aperiodic as well as periodic PUCCH resources for HARQ-ACK feedback. Certain embodiments relate to third generation partnership project (3GPP) long term evolution (LTE) Licensed Assisted Access (LAA) enhancements, such as support for uplink operation, as well as possible stand-alone operation on unlicensed carriers.

From a quality of service, such as latency, point of view, the UE may need to be able to transmit HARQ-ACK feedback as response to DL data transmission as soon as possible. Negative LBT, such as the UE not being able to transmit due to operating channel being occupied, may cause undesired delay in the HARQ-ACK feedback. It may be possible to use periodic PUCCH resources for HARQ-ACK signaling. This provides additional opportunities for UE to convey HARQ-ACK. Furthermore, such resources may provide an efficient approach in terms of additional UL overhead and DL overhead. It's also noted that according to certain regulatory rules, it may be possible to convey HARQ-ACK via periodic PUCCH resources also without LBT procedure.

Certain embodiments address how to efficiently use periodic PUCCH for HARQ-ACK signaling when LBT prevents HARQ-ACK transmission using Fast PUCCH. Likewise, certain embodiments explain how to trigger transmission on Periodic PUCCH. Furthermore, certain embodiments provide a way to deal with limited capacity of periodic PUCCH container. Additionally, certain embodiments appropriately arrange resource allocation.

More particularly, certain embodiments may provide a framework for indicating by the eNB, or other access node, and determining by the UE or other user device, a resource for HARQ-ACK transmission, depending on LBT outcome. An indication can be based on an ACK/NACK resource indicator (ARI) of 2-3 bits, included into each DL assignment. The ARI can correspond to two or three sets of 4-8 RRC configured resources. The number of ARI bits may be defined by the specification. eNB may also configure the number of ARI bits via higher layer signalling.

One set of RRC configured resources can be for aperiodic (Fast) PUCCH immediately following the DL transmission burst. The second and possibly third set can be for periodic PUCCH or corresponding to PUCCH resources on a licensed carrier, which uses LTE Frame Structure 1 or 2 (unlicensed band operation may follow LTE Frame Structure 3).

Based on the outcome of the LBT procedure, the UE can determine one or more of the following. For example, the UE can determine in which subframe to transmit HARQ-ACK. For instance, the HARQ-ACK may be transmitted immediately following the DL transmission burst, using Aperiodic PUCCH. This may be the case when UE detects that the following transmission burst is present. UE may also detect aperiodic PUCCH trigger by eNB, which may indicate that UE transmits HARQ-ACK via triggered PUCCH. UE may also detect UL grant and multiplex HARQ-ACK with UL data on PUSCH or puncture HARQ-ACK on PUSCH. Alternatively, the HARQ-ACK may be transmitted in the next periodic PUCCH resource. It's also possible to trigger a short PUCCH (following similar structure as periodic PUCCH) in such a way that it collides in certain time instant with periodic PUCCH. When following this option, certain UEs may operate according to rules defined for periodic PUCCH whereas some other UEs may operate according to rules defined for triggered PUCCH.

Additionally or alternatively, the UE can determine on which carrier to send the HARQ-ACK. This option may assume the UE is carrier aggregation capable, for example LAA Rel-14 operation. In one option the UE can use unlicensed carrier, or Frame Structure (FS) 3, when LBT has been successful. In the case LBT has not been successful, the UE can transmit HARQ-ACK on a licensed carrier, or a carrier using some other frame structure, such as FS1 or FS2.

Additionally, or alternatively, the UE can determine which short PUCCH format to apply. Short PUCCH may support, for example two different formats for HARQ-ACK transmission. A first supported format may be for aperiodic HARQ-ACK immediately after DL transmission burst. Another supported format may be for, for example, periodic PUCCH, with reduced overhead and payload.

Additionally, or alternatively, the UE can determine how to determine HARQ-ACK feedback. For example, in the case of positive LBT, all HARQ-ACK bits may be transmitted, namely the HARQ-ACK bits corresponding to all received downlink transport blocks and subframe(s). In the case of negative LBT, spatial and/or time domain and/or frequency domain bundling of HARQ-ACK bits can be applied.

Additionally, or alternatively, the UE can determine which of the ARI resources sets to use. A first set of resources can be used in case UE's LBT is successful and aperiodic short PUCCH is used for HARQ-ACK transmission immediately following the DL transmission burst. The second set of resources can be used in case UE's LBT is not successful. In this case, the HARQ-ACKs can be carried over periodic PUCCH. Alternatively, the HARQ-ACK can be carried over a licensed carrier. The third set of resources may be used when UE's LBT is successful and HARQ-ACK for last subframes of DL transmission burst, for example one limited by UE processing time, is conveyed via periodic PUCCH.

Higher layer configuration of a resource in an ARI resource set may define block-interleaved frequency division multiple access (B-IFDMA) interlace, orthogonal cover code (OCC), and cyclic shift. In the case of fallback to licensed band operation, ARI configuration may also or alternatively indicate the PUCCH resources, timing, and/or PUCCH cell index.

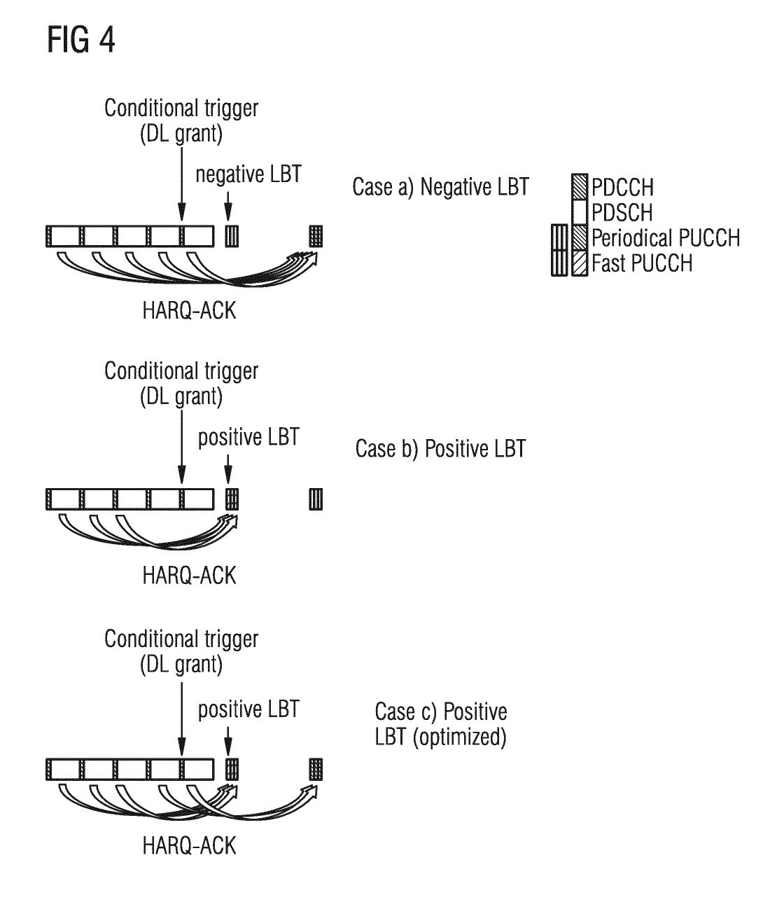

FIG. 4 illustrates principles of certain embodiments, and FIG. 5 illustrates further principles of certain embodiments. Together, FIGS. 4 and 5 illustrates four cases, labelled (a) through (d), which are discussed below.

Case (a) corresponds to a case with negative LBT. In such a case, the channel is occupied right after the end of DL transmission burst, and HARQ-ACK transmission must be postponed. Case (b), by contrast, corresponds to a case with positive LBT. Thus, the channel is vacant after the end of DL transmission burst, and HARQ-ACK transmission can be performed using Aperiodic Short PUCCH. These two cases can be referred to as a baseline solution.

One of the issues related to the baseline solution is that usage of periodic PUCCH resource might be limited to the case with a fixed-size HARQ-ACK codebook. The limitation on number of bits may be due to the fact that eNB may not know the UE's LBT status. This means that in the case of baseline solution the codebook size/subframe bundling window applied with the periodic resource may need to be fixed and known by the eNB.

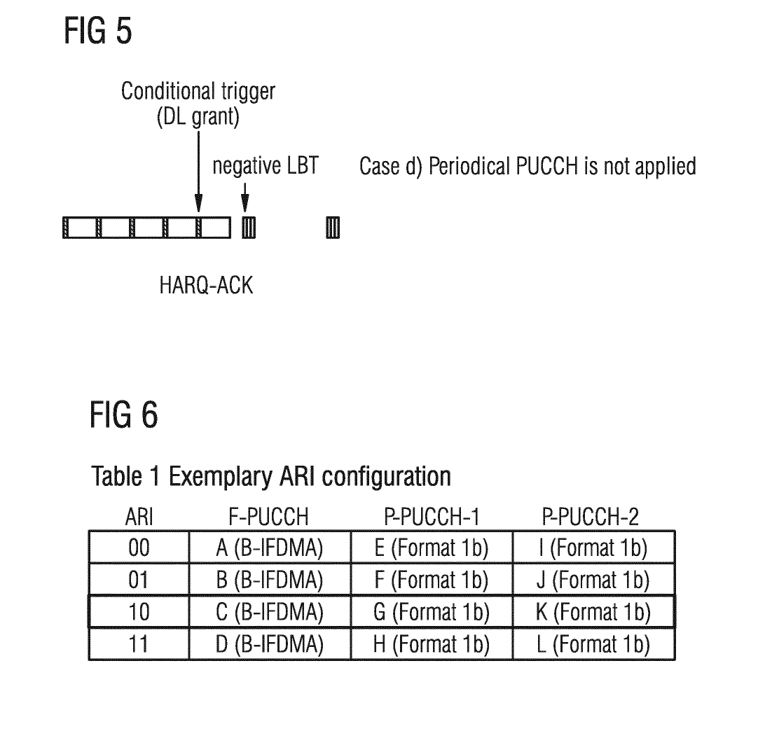

FIG. 4, case (c) shows an improvement where periodic PUCCH can support a variable HARQ-ACK codebook size. This can work in the following way. The eNB can configure three sets of resources for a UE (see Table 1 in FIG. 6). In the current example, and as shown in FIG. 6, eNB can configure four ARI values for each set of resources: F-PUCCH, P-PUCCH-1 and P-PUCCH2.

The eNB can select one of the resource sets for the UE, such as the resource set corresponding to ARI=“10” in the example highlighted in FIG. 6. When LBT is negative, and there is no DL assignment in the following DL transmission burst, the UE can operate according to case (a). Thus, HARQ-ACK can be transmitted via periodic PUCCH only. The UE can utilize resource G (P-PUCCH), predetermined bundling/multiplexing and the corresponding codebook size.

On the other hand, when LBT is positive, a predetermined part of HARQ-ACK can be transmitted via fast PUCCH, denoted as F-PUCCH in FIG. 6, using resource C. If needed, it may be possible to apply codebook based on the number of HARQ-processes here.

The latter part of the HARQ-ACK, for example one limited by UE processing time, can be conveyed via periodical PUCCH, denoted P-PUCCH-2 in FIG. 6, and resource K if no DL grant or other signaling indicating the presence of DL burst (such as common signaling) in the following transmission opportunity (TxOP) is detected.

In certain embodiments, the DL grant can include downlink assignment index (DAI) bits, such as DAI counter and/or total DAI. UE may use those bits to determine DL grant errors.

It may be possible to define a desired bundling/multiplexing solution separately for each F-PUCCH, P-PUCCH-1 and P-PUCCH-2 resource (i.e. resources A-D, E-H and I-L in FIG. 6), and also separately for different ARI code points (i.e. resources A-L in FIG. 6).

In certain embodiments, HARQ-ACK may never be transmitted via periodic PUCCH without trigger. This can be supported by an additional bit in DL grant. For example, the bit can be used to select between option 1, in which periodic PUCCH is used (FIG. 4 case a, FIG. 4 case c) and option 2, in which periodical PUCCH is not used (FIG. 4 case b, FIG. 5 case d). Another option can be to select between Option 1 and Option 2 using higher layer configuration.

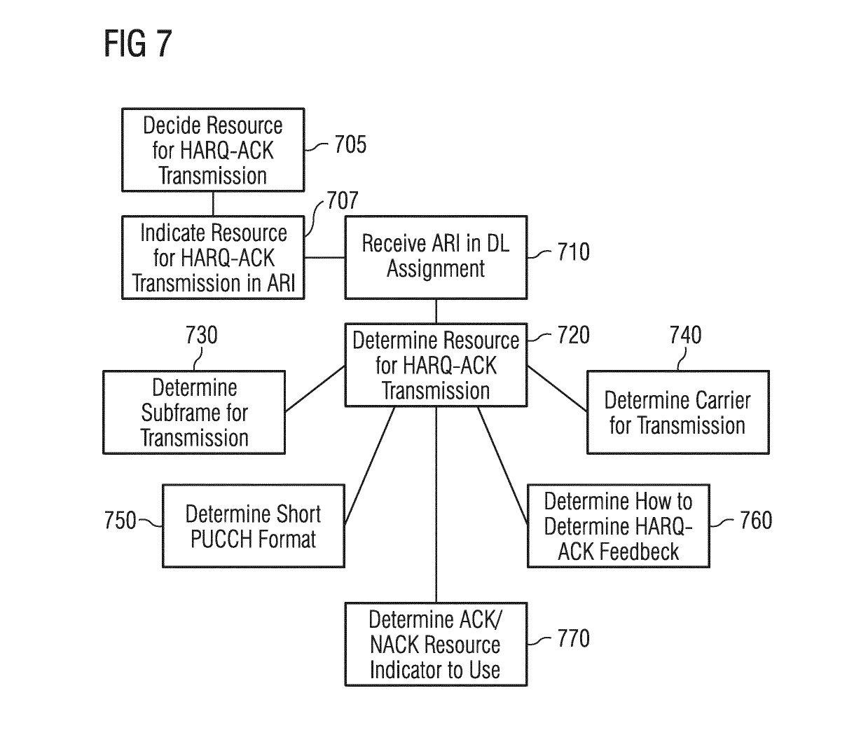

FIG. 7 illustrates a method according to certain embodiments. As shown in FIG. 7, a method can include, at 710, receiving, from an access node, an acknowledgment/negative acknowledgement resource indicator in a downlink assignment. The method can also include, at 720, determining, by a user equipment, a resource for hybrid automatic repeat request acknowledgment transmission based on the acknowledgment/negative acknowledgement resource indicator.

The method can further include, at 705, deciding a resource to be used by a user equipment for hybrid automatic repeat request acknowledgment transmission. The method can additionally include, at 707, indicating, by an access node, the resource using an acknowledgment/negative acknowledgement resource indicator in a downlink assignment. Thus, this indicated resource can be the same resource received at 710.

The indicator can correspond to two or three sets of four to eight radio resource control configured resources. For example, the indicator can correspond to anywhere from two sets of four resources to three sets of eight resources. Other configurations are also permitted. For example, only certain codepoints (e.g. 7 out of 8) can be defined to be valid code points with configured resources.

A first set of the radio resource control configured resources can be for aperiodic physical uplink control channel immediately following a downlink transmission burst. The second and/or third set of the radio resource control configured resources can be for periodic physical uplink control channel or corresponding to physical uplink control channel resources on a licensed carrier, or carrier not applying any listen before talk procedure.

The method can also include, at 730, determining, by the user equipment, in which subframe to transmit hybrid automatic repeat request acknowledgment, based on an outcome of a listen before talk procedure and the indicator.

The method can further include, at 740, determining, by the user equipment, on which carrier to transmit hybrid automatic repeat request acknowledgment, based on an outcome of a listen before talk procedure and the indicator.

The method can additionally include, at 750, determining, by the user equipment, which short physical uplink control channel format to apply, based on an outcome of a listen before talk procedure and the indicator.

The method can also include, at 760, determining, by the user equipment, how to determine hybrid automatic repeat request acknowledgment feedback, based on an outcome of a listen before talk procedure and the indicator.

The method can further include, at 770, determining, by the user equipment, which acknowledgment/negative acknowledgment resource indicator set to use, based on an outcome of a listen before talk procedure and the indicator.

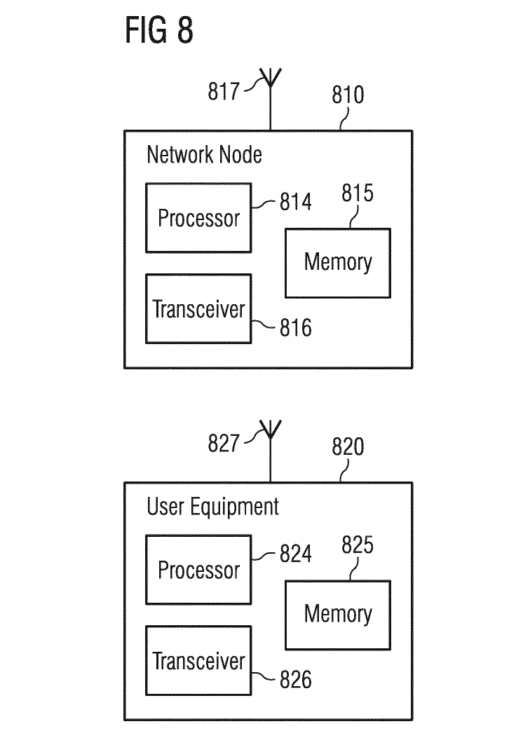

FIG. 8 illustrates a system according to certain embodiments of the invention. It should be understood that each block of the flowchart of FIG. 7 may be implemented by various means or their combinations, such as hardware, software, firmware, one or more processors and/or circuitry. In one embodiment, a system may include several devices, such as, for example, network element 810 and user equipment (UE) or user device 820. The system may include more than one UE 820 and more than one network element 810, although only one of each is shown for the purposes of illustration. A network element can be an access point, a base station, an eNode B (eNB), or any other network element, such as a PCell base station or a SCell base station.

Each of these devices may include at least one processor or control unit or module, respectively indicated as 814 and 824. At least one memory may be provided in each device, and indicated as 815 and 825, respectively. The memory may include computer program instructions or computer code contained therein, for example for carrying out the embodiments described above. One or more transceiver 816 and 826 may be provided, and each device may also include an antenna, respectively illustrated as 817 and 827. Although only one antenna each is shown, many antennas and multiple antenna elements may be provided to each of the devices. Other configurations of these devices, for example, may be provided. For example, network element 810 and UE 820 may be additionally configured for wired communication, in addition to wireless communication, and in such a case antennas 817 and 827 may illustrate any form of communication hardware, without being limited to merely an antenna.

Transceivers 816 and 826 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 820 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. The user device or user equipment 820 may be a sensor or smart meter, or other device that may usually be configured for a single location.

In an exemplifying embodiment, an apparatus, such as a node or user device, may include means for carrying out embodiments described above in relation to FIG. 7.

Processors 814 and 824 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or unit of at least one chip set (e.g., procedures, functions, and so on). Memories 815 and 825 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 810 and/or UE 820, to perform any of the processes described above (see, for example, FIG. 7). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 8 illustrates a system including a network element 810 and a UE 820, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may have small DCI overhead. Additionally, certain embodiments may have improved quality of service or lower latency compared to a he case when periodic PUCCH is not used for signaling. Moreover, certain embodiments may have reduced UL overhead compared to the case when periodic PUCCH is not used for signaling. Furthermore, certain embodiments allow usage of periodic PUCCH resources in multiple ways, include positive/negative LBT for fast PUCCH.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

3GPP Third Generation Partnership Project
ACK Acknowledgement
ATI Aperiodic Time Identity
B-IFDMA Block Interleaved Frequency Division Multiple Access
BW BandWidth
CA Carrier Aggregation
CCE Control Channel Element
CDM Code Division Multiplexing
CRC Cyclic Redundancy Check
CSI Channel State Information
DCI Downlink Control Information
DL Downlink
DM RS DeModulation Reference Signal
eNB Evolved NodeB
ETSI European Telecommunications Standards Institute
FDD Frequency Division Duplex
FDM Frequency Division Multiplex
HARQ Hybrid Automatic Repeat Request
IFDMA Interleaved Frequency Division Multiple Access
LAA Licensed Assisted Access
LBT Listen-Before-Talk
LTE Long Term Evolution
NACK Negative Acknowledgement
OFDMA Orthogonal Frequency Division Multiplexing
SC-FDMA Single-Carrier Frequency Division Multiplexing
PCell Primary cell
P-CSI Periodic Channel State Information
PDSCH Physical Downlink Shared Control Channel
PRACH Physical Random Access Channel
PUCCH Physical Uplink Control Channel
PUSCH Physical Uplink Shared Channel
RPF RePetition Factor
SCell Secondary cell (operating on un-licensed carrier in certain embodiments)
SCS Short Control Signalling
SR Scheduling Request
SRS Sounding Reference Signal
TB Transmission Block
TDD Time Division Duplex
TDM Time Division Multiplex
Tx Transmission
TXOP Transmission Opportunity
UCI Uplink Control Information
UE User Equipment
UL Uplink

1. A method, comprising:
receiving, from an access node, an acknowledgment/negative acknowledgement resource indicator in a downlink assignment, wherein the indicator corresponds to two or three resource sets; and
determining, by a user equipment, a resource for hybrid automatic repeat request acknowledgment transmission based on the acknowledgment/negative acknowledgement resource indicator and based on an outcome of a listen before talk procedure.

2. A method, comprising:
deciding a resource to be used by a user equipment for hybrid automatic repeat request acknowledgment transmission; and
indicating, by an access node, the resource using an acknowledgment/negative acknowledgement resource indicator in a downlink assignment, wherein the indicator corresponds to two or three resource sets, and wherein the indicator is configured to be considered in combination with an outcome of a listen before talk procedure.

3. The method of claim 1, wherein the indicator corresponds to two or three sets of four to eight radio resource control configured resources.

4. The method of claim 3, wherein a first set of the radio resource control configured resources is for aperiodic physical uplink control channel immediately following a downlink transmission burst.

5. The method of claim 3, wherein at least one of a second set or a third set of the radio resource control configured resources is for periodic physical uplink control channel or corresponding to physical uplink control channel resources on a carrier not configured to apply any listen before talk procedure.

6. The method of claim 1, further comprising:
determining, by the user equipment, in which subframe to transmit hybrid automatic repeat request acknowledgment, based on an outcome of a listen before talk procedure and the indicator.

7. The method of claim 1, further comprising:
determining, by the user equipment, on which carrier to transmit hybrid automatic repeat request acknowledgment, based on an outcome of a listen before talk procedure and the indicator.

8. The method of claim 1, further comprising:
determining, by the user equipment, which short physical uplink control channel format to apply, based on an outcome of a listen before talk procedure and the indicator.

9. The method of claim 1, further comprising:
determining, by the user equipment, how to determine hybrid automatic repeat request acknowledgment feedback, based on an outcome of a listen before talk procedure and the indicator.

10. The method of claim 1, further comprising:
determining, by the user equipment, which acknowledgment/negative acknowledgment resource indicator set to use, based on an outcome of a listen before talk procedure and the indicator.

11. An apparatus, comprising:
at least one processor; and
at least one memory including computer program code,
wherein the at least one memory and the computer program code are configured to, with the at least one processor, cause the apparatus at least to
receive, from an access node, an acknowledgment/negative acknowledgement resource indicator in a downlink assignment, wherein the indicator corresponds to two or three resource sets; and
determine, by a user equipment, a resource for hybrid automatic repeat request acknowledgment transmission based on the acknowledgment/negative acknowledgement resource indicator and based on an outcome of a listen before talk procedure.

12. An apparatus, comprising:
at least one processor; and
at least one memory including computer program code,
wherein the at least one memory and the computer program code are configured to, with the at least one processor, cause the apparatus at least to
decide a resource to be used by a user equipment for hybrid automatic repeat request acknowledgment transmission; and
indicate, by an access node, the resource using an acknowledgment/negative acknowledgement resource indicator in a downlink assignment, wherein the indicator corresponds to two or three resource sets, and wherein the indicator is configured to be considered in combination with an outcome of a listen before talk procedure.

13. The apparatus of claim 12, wherein the indicator corresponds to two or three sets of four to eight radio resource control configured resources.

14. The apparatus of claim 13, wherein a first set of the radio resource control configured resources is for aperiodic physical uplink control channel immediately following a downlink transmission burst.

15. The apparatus of claim 13, wherein at least one of a second set or a third set of the radio resource control configured resources is for periodic physical uplink control channel or corresponding to physical uplink control channel resources on a carrier not configured to apply any listen before talk procedure.

16.-31. (canceled)

32. A non-transitory computer-readable medium encoded with instructions that, when executed in hardware, perform a process, the process comprising the method according to claim 1.

33. A non-transitory computer-readable medium encoded with instructions that, when executed in hardware, perform a process, the process comprising the method according to claim 2.
